(19) United States
(12) Patent Application Publication
(10) Pub. No.: US 2006/0217486 A1
(43) Pub. Date: Sep. 28, 2006

(54) Pigment formulations and paint compositions comprising the formulations

(76) Inventors: Yoshinori Ohyama, Nishinomiya-shi (JP); Makoto Ueda, Isehara-shi (JP); Akihiko Yamanouchi, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/385,761

(22) Filed: Mar. 22, 2006

(30) Foreign Application Priority Data
Mar. 22, 2005 (JP) 2005-80792

(51) Int. Cl. C08L 33/06

(52) U.S. Cl. 524/560

(57) ABSTRACT

This invention provides pigment formulations excelling in dispersibility and paint compositions comprising them. The pigment formulation is powdery and comprises resin and pigment as dispersed in the resin matrix, the resin being composed of a copolymer comprising polymerizable unsaturated monomer units having at least one kind of functional groups selected from tertiary amino, quaternary ammonium salt and sulfo groups and other ethylenically unsaturated monomer units, and having a glass transition temperature within a range of 40-150° C.

### TECHNICAL FIELD

This invention relates to pigment formulations having excellent dispersibility and also to paint compositions comprising the same.

### BACKGROUND ART

Pigment formulations to color various materials have been conventionally prepared by such methods as mixing pigment powder with dispersant and/or dispersing resin and solvent and giving a dispersing treatment; melt-kneading pigment powder and dispersant and/or dispersing resin with rolls or a kneader; dry-mixing pigment powder with dispersant and/or dispersing resin; or the like. In particular, as powdery pigment formulations to be blended with such materials as paint, ink or plastics, usually those prepared by melt-kneading method or dry mixing method have been used.

As an example of such powdery pigment formulations, for example, JP Sho50(1975)-122527A disclosed preparation of colored coating compositions excelling in dispersibility and film-forming property, using a powdery pigment formulation which was obtained by kneading a specific carboxyl- or hydroxyl-containing acrylic resin with pigment powder. Also JP2003-105224A disclosed preparation of easily dispersible pigment formulation by kneading urea-aldehyde resin and/or urea-ketone resin with pigment powder. JP2004-10778A furthermore disclosed preparation of pigment formulations excelling in tinting strength or color stability, by dry-grinding a mixture composed of each specific amount of coloring pigment, extender and resin.

Dispersion levels of those pigment formulations which are obtained by the methods as described in above patent literature, however, are at the best in the order of several tens of microns in terms of fineness gauge, and it is extremely difficult to further raise their dispersion level. This produces a problem that the pigment formulations are incapable of forming, when blended in paint, coating films of fully satisfactory image sharpness or of high transparency, depending on the kind of coloring pigment used. In particular, when carbon black, organic coloring pigment or the like are used as the pigment, those known pigment formulations show a defect that they cannot form coating films of high jet-black quality or transparency.

### DISCLOSURE OF THE INVENTION

The main object of the present invention is to provide pigment formulations excelling in dispersibility, which are particularly useful for coloring paint, and paint compositions containing them.

We have engaged in extensive studies for accomplishing the above object, and in consequence now discovered that pigment formulations showing excellent dispersibility could be obtained by use of, as the dispersing resin, a specific copolymer having functional group(s) selected from tertiary amino groups, quaternary ammonium salt groups and sulfo groups. The present invention is whereupon completed.

Thus, the present invention provides a powdery pigment formulation comprising resin (A) and pigment (B) which is dispersed in the resin matrix, characterized in that the resin (A) is composed of a copolymer comprising polymerizable unsaturated monomer (a) unit having at least one functional group selected from tertiary amino, quaternary ammonium salt and sulfo groups, and other ethylenically unsaturated monomer (b) unit; and has glass transition temperature within a range of 40-150° C.

The invention also provides a paint composition which contains the pigment formulation.

According to the invention, use of the specified copolymer as the dispersing resin achieves drastic improvement in dispersion level of pigment particles compared with the case of using resins as heretofore proposed. In particular, pigment formulations which give high quality jet-black coating film or that of excellent image sharpness and transparency can be obtained even when carbon black or organic coloring pigment are used as the pigment.

Therefore, the pigment formulations of the present invention are extremely useful for blending into various types of paint such as organic solvent-based, water-based and powder paints.

Hereinafter the pigment formulations of the present invention and paint compositions containing them are explained in further details.

Resin (A)

In a formulation according to the present invention, a resin (A) composed of a copolymer obtained through copolymerization of a polymerizable unsaturated monomer (a) having at least one functional group selected from the group consisting of tertiary amino groups, quaternary ammonium salt groups and sulfo groups with an other ethynetically unsaturated monomer (b), is used as a dispersing resin.

As (i) polymerizable unsaturated monomers having tertiary amino group which are useful as the monomer (a), for example, N,N-dialkylaminoalkyl(meth)acrylate such as N,N-dimethylaminoethyl(meth)acrylate, N,N-diethylaminoethyl(meth)acrylate, N,N-dimethylaminopropyl(meth)acrylate and N,N-dimethylaminobutyl(meth)acrylate; and N,N-dialkylaminoalkyl(meth)acrylamide such as N,N-dimethylaminoethyl(meth)acrylamide, N,N-diethylaminoethyl(meth)acrylamide and N,N-dimethylaminopropyl(meth)acrylamide, and the like can be named. As (ii) polymerizable unsaturated monomers having quaternary ammonium salt group, for example, (meth)acryloyloxyalkyltrialkyl ammonium salts such as 2-(methacryloyloxy)ethyltrimethylammonium chloride, 2-(methacryloyloxyoy)etyltrimethylammonium bromide and 2-(methacryloyloxy)ethyltrimethylammonium dimethylphosphate; (meth)acryloylaminoalkyltrialkylammonium salts such as methacryloylaminopropyltrimethyl ammonium chloride and methacryloylaminopropyltrimethylammonium bromide; tetraalkylammonium(meth)acrylates such as tetrabutylammonium(meth)acrylate; and trialkylaralkylammonium(meth)acrylate such as trimethylbenzylammonium(meth)acrylate, and the like are named. As (iii) polymerizable unsaturated monomers having sulfo group, for example, (meth)acrylamido-alkanesulfonic acid such as 2-acrylamido-2-methylpropanesulfonic acid (t-butylacrylamidosulfonic acid); and sulfoalkyl(meth)acrylate such as 2-sulfoethyl(meth)acrylate, and the like can be named. These monomers can be used each singly or in combination of two or more. Of these, as the monomer (a), particularly N,N-dimethylaminoethyl (meth)acrylate, N,N-diethylaminoethyl(meth)acrylate, 2-(methacryloyloxy)ethyltrimethylammonium chloride and 2-acrylamido-2-methylsulfonic acid are preferred.

In this specification, the term “(meth)acrylate” means “acrylate or methacrylate”, and “(meth)acrylic” means “acrylic or methacrylic”.

Whereas, monomer (b) encompasses monomers having polymerizable unsaturated groups other than above-described monomer (a) and which are copolymerizable with the monomer (a). The monomers can be suitably selected according to the desired properties for individual resin (A). As specific examples of such monomer (b), linear, branched or cyclic C₁-C₂₄ alkyl(meth)acrylates such as methyl(meth)acrylate, ethyl(meth)acrylate, n-propyl (meth)acrylate, isopropyl(meth)acrylate, n-butyl(meth)acrylate, isobutyl(meth)acrylate, tert-butyl(meth)acrylate, 2-ethylhexyl(meth)acrylate, n-octyl(meth)acrylate, lauryl(meth)acrylate, stearyl(meth)acrylate, cyclohexyl(meth)acrylate, isobornyl(meth)acrylate and tridecyl(meth)acrylate; hydroxyl-containing polymerizable unsaturated monomers such as C₁-C₂₄ hydroxyalkyl(meth)acrylates, e.g., 2-hydroxyethyl(meth)acrylate, hydroxypropyl(meth)acrylate and hydroxylbutyl(meth)acrylate; carboxyl-containing polymerizable unsaturated monomers such as (meth)acrylic acid; phosphate-containing polymerizable unsaturated monomers such as 2-methacryloyloxyethyl acidphosphate, 2-allyloyloxyethyl acidphosphate and polymerizable unsaturated monomers obtained by adding glycidyl methacrylate to monoalkyl (e.g., butyl, decyl, lauryl or stearyl)phosphoric acid; oxetane ring-containing (meth)acrylates such as (meth)-acrylamide, 3-methyl-3-(meth)acryloyloxymethyloxetane, 3-ethyl-3-(meth)acryloyloxymethyloxteane and 3-butyl-3-(meth)acryloyloxymethyloxetane; UV-absorbing polymerizable unsaturated monomers such as 2-(2′-hydroxy-5′methacryloyloxymethylphenyl)-2H-benzotriazole; UV-stable polymerizable unsaturated monomers such as 4-(meth)acryloyloxy-1,2,2,6,6-pentamethylpiperidine; aromatic vinyl compounds such as styrene, α-methylstyrene and vinyltoluene; (meth)acrylonitrile, vinyl acetate and the like can be named. These polymerizable unsaturated monomers can be used either each singly or in combination of two or more.

In an occasion of blending a pigment formulation of the present invention in paint, it is desirable to use, as at least a part of the monomer (b), hydroxyl-containing polymerizable unsaturated monomer, to enable formation of hardened coating film through its reaction with a hardener component in the paint, for example, amino resin or optionally blocked polyisocyanate compound. Where such hydroxyl-containing polymerizable monomer(s) are used, their use rate normally falls within a range of 2-30 mass %, preferably 4-20 mass %, based on the combined amount of the monomer (a) and monomer (b).

From the standpoints of dispersibility of basic pigment, crosslinking reactivity with amino resin and aqueous dispersion stability of the formulation when blended in a water-based paint, it is desirable to use, as at least a part of the monomer (b), a carboxyl-containing polymerizable unsaturated monomer. Where the carboxyl-containing polymerizable unsaturated monomer is used, its use rate is normally within a range of 0.01-20 mass %, preferably within a range of 0.5-10 mass %, based on the combined amount of the monomer (a) and monomer (b).

When a pigment formulation of the present invention is blended in water-based paint, polyoxyalkylene chain-containing polymerizable unsaturated monomer can be used as at least a part of the monomer (b), to impart hydrophilicity to the resulting copolymer. As the polyoxyalkylene chain, polyoxyethylene chain, polyoxypropylene chain or block chain of polyoxyethylene and polyoxypropylene can be named. Where polymerizable unsaturated monomer(s) containing these polyoxyalkylene chains are used, their use rate is normally within a range of 1-40 mass %, preferably within a range of 3-25 mass %, based on the combined amount of the monomer (a) and monomer (b).

Through copolymerization of above monomer(s) (a) and monomer(s) (b), a copolymer useful as the resin (A) can be obtained. From the standpoint of pigment dispersibility, the copolymerization ratio of the monomer (a) and monomer (b) can generally range 0.1-20 mass %, in particular, 0.2-8 mass %, of monomer (a) to 80-99.9 mass %, in particular, 92-99.8 mass %, of monomer (b).

Copolymerization of above monomer (a) and monomer (b) can be conducted by per se known means, for example, solution polymerization method in organic solvent or emulsion polymerization method in water, solution polymerization method being particularly convenient. The copolymerization by solution polymerization method can be conducted, for example, by dissolving or dispersing a mixture of the monomeric components with radical polymerization initiator in organic solvent, and carrying out the polymerization by heating under agitation normally at about 80° C.-about 200° C. for normally around 1-10 hours.

As organic solvent useful in the occasion of copolymerization, for example, hydrocarbon solvents such as heptane, toluene, xylene, octane and mineral spirit; ester solvents such as ethyl acetate, n-butyl acetate, isobutyl acetate, ethylene glycol monomethyl ether acetate and diethylene glycol monobutyl ether acetate; ketone solvents such as methyl ethyl ketone, methyl isobutyl ketone, diisobutyl ketone and cyclohexanone; alcohol solvents such as methanol, ethanol, isopropanol, n-butanol, sec-butanol and isobutanol; ether solvents such as n-butyl ether, dioxane, ethylene glycol monomethyl ether and ethylene glycol monoethyl ether; and aromatic petroleum solvents such as SWAZOL™ 310, SWAZOL™ 1000 and SWAZOL™ 1500 (COSMO Oil Co., Ltd.) can be named. These organic solvents can be used each singly or in combination of two or more. In the polymerization reaction time, the organic solvent can be used within a range of normally not more than 400 mass parts, per 100 mass parts of combined monomeric components.

As the radical polymerization initiator, for example, organic peroxide polymerization initiators including ketone peroxides such as cyclohexanone peroxide, 3,3,5-trimethylcyclohexanone peroxide and methylcyclohexanone peroxide; peroxy ketals such as 1,1-bis(tert-butylperoxy)-3,3,5-trimethylcyclohexane, 1,1-bis(tert-butylperoxy)cyclohexane and n-butyl-4,4-bis(tert-butylperoxy)valerate; hydroperoxides such as cumene hydroperoxide and 2,5-dimethylhexane-2,5-dihydroperoxide; dialkyl peroxides such as 1,3-bis(tert-butylperoxy-m-isopropy)benzene, 2,5-dimethyl-2,5-di(tert-butylperoxy)hexane, diisopropylbenzene peroxide and tert-butylcumyl peroxide; diacyl peroxides such as decanoyl peroxide, lauroyl peroxide, benzoyl peroxide and 2,4-dichlorobenzoyl peroxide; peroxycarbonates such as bis(tert-butylcyclohexyl) peroxydicarbonate; and peroxy esters such as tert-butyl peroxybenzoate and 2,5-dimethyl-2,5-di(benzoylperoxy)hexane: and azo polymerization initiators including 2,2′-azobisisobutyronitile, 1,1-azobis(cyclohexane-1-carbonitrile), azocumene-2,2-azobismethylvaleronitrile and 4,4′-azobis(4-cyanovaleric acid) can be named. Use rate of these radical polymerization initiators are subject to no particular limitation, while it is normally desirable to be within a range of 0.1-15 mass parts, in particular, 0.3-10 mass parts, per 100 mass parts of the combined amount of the monomer (a) and monomer (b).

Where necessary, chain transfer agent may be used for controlling molecular weight of the copolymer. As examples of useful chain transfer agent, mercapto compounds such as mercaptoethanol and octyl-3-mercaptopropionate can be named. Use rate of such a chain transfer agent is subject to no particular limitation, while it can normally be within a range of 0.01-10 mass parts, preferably 0.1-5 mass parts, base on 100 mass parts of combined amount of the monomer (a) and monomer (b).

In the above polymerization reaction, methods of adding the monomeric components, polymerization initiator or the like are not particularly limited, but for the purpose of temperature control during the polymerization reaction or suppression of formation of undesirable crosslinked product such as gel, the polymerization initiator is more conveniently added dropwise in several portions over the time from initial stage to the late stage of the polymerization, rather than adding it all at once at the initial stage.

The molecular weight of so formed copolymer is not particularly limited, while it can generally be within a range of, in terms of weight-average molecular weight, 500-100,000, in particular, 1,000-50,000, inter alia, 5,000-20,000 being preferred, in consideration of stability of aqueous dispersion, pigment dispersibility, viscosity, VOC (volatile organic compounds) and color number (degree of coloring) of the resin.

In the present specification, weight-average molecular weight is a value of weight-average molecular weight of a sample as measured by means of gel permeation chromatograph (Tosoh Corporation, tradename “HLC812OGPC”), which is converted based on the weight-average molecular weight of polystyrene. The measurement was conducted under the conditions of using four columns, “TSKgel G-4000 H×L” “TSKgel G-3000 H×L” “TSKgel G-2500 H×L” and “TSKgel G-2000 H×L” (all by Tosoh Corporation, tradename) at mobile phase: tetrahydrofuran, measuring temp.: 40° C., flow rate: 1 cc/min. and the detecter: RI.

It is important for the copolymer to be used in the present invention to have a glass transition temperature within a range of 40-150° C., preferably 50-120° C., inter alia, 50-80° C. Where the copolymer has a glass transition temperature lower than 40° C., blocking is apt to take place during mixing of pigment (B) and resin (A). Conversely, where the temperature exceeds 150° C., many hours are required for heat-melting of the resin (A), which is undesirable. It is, therefore, desirable to select suitable kinds of monomer (a) and monomer (b) for the copolymerization, so that the resulting copolymer would have a glass transition temperature within the above-specified range.

In the present specification, glass transition temperature (° C.) of copolymer is calculated by the following equations:
1/Tg(° K)=(W1/T1)+(W2/T2) + . . .
Tg(° C.)=Tg(° K)−273

in which W1, W2 . . . are weight percent of each of the monomers to be copolymerized, and

T1, T2 . . . stand for Tg(° K) of homopolymer of each monomer.

Furthermore, T1, T2 . . . are the values found in Polymer Handbook (Second Edition, ed. by J. Brandup and E. H. Immergut) III, pp. 139-179. Where Tg of a homopolymer of any monomer was not precisely known, static glass transition temperature of the same homopolymer is used as the glass transition temperature (° C.). For example, differential scanning calorimeter, “DSC-220U” (SEIKO Instruments Inc., tradename) was used to measure calorific change of a sample taken into its measuring cup and from which the solvent was completely removed by vacuum suction, under a temperature rise rate of 3° C./min. within a range of −20° C. to +200° C., and the first baseline change point on the low temperature side was recorded as the static glass transition temperature.

A copolymer solution obtained as above is normally given a solvent-removing treatment and suitably pulverized and thereafter can be used as resin (A). Thus obtained resin (A) powder normally has average particle diameter within a range of 50-5,000 μm, in particular, a range of 100-1,000 μm being preferred.

According to the invention, resin (A) preferably has a softening point ranging normally 40-200° C., in particular, 80-140° C., in consideration of easier operating temperature control in the occasion of melt-kneading the resin (A) with pigment (B).

In the present specification, softening point of resin (A) can be measured with differential scanning calorimeter, “DSC-220U” (SEIKO Instruments Inc., tradename). More specifically, resin (A) is ground in a mortar and so adjusted of its particle size that the maximum particle diameter is not more than 0.5 mm, which is used as the measuring sample. Five (5) mg of the sample is taken and fed into the calorimeter and its calorific change is measured at a temperature rise rate of 10° C./min. within a range of −20° C. to +200° C., and the peak temperature of the DSC curve during the temperature rise, which indicates melting, is read. This temperature is recorded to be the softening point of the measured sample.

Tertiary amino group and/or quaternary ammonium salt group present in the monomer (a) effectively work to improve pigment dispersibility particularly of acidic pigment or neutral pigment, while sulfo group effectively works to improve pigment dispersibility particularly of basic pigment. Therefore, resin (A) composed of the copolymer prepared from monomer (a) having tertiary amino group and/or quaternary ammonium salt group is conveniently used with acidic pigment or neutral pigment, and that composed of a copolymer prepared from monomer (a) having sulfo group is conveniently used with basic pigment.

Pigment (B)

Pigment (B) in formulations of the present invention are subject to no particular restriction, and pigments customarily used in the field of paint or ink or that of resin processing can be used in similar manner. More specifically, for example, organic coloring pigments such as quinacridone (e.g., Pink EB), azo, perylene, phthalocyanine (e.g., Cyanine Blue, Cyanine Green), benzoimidazolone, isoindoline and quinophthalone; inorganic coloring pigments such as titanium dioxide, Titan Yellow, red iron oxide, carbon black, chrome yellow, iron oxide and various calcined pigments; effect pigments such as aluminium powder, copper powder, nickel powder, stainless steel powder, chrome powder, micaceous iron oxide, titanium oxide-coated mica powder, iron oxide-coated mica powder and bright graphite can be named. Extenders such as calcium carbonate, magnesium carbonate, barium sulfate, silicic acid, silicate, aluminum hydrate, or calcium sulfate can also be suitably combined with those pigments as above-named, to be used as pigment (B). These pigments may be surface-treated in advance by the means known per se, for example, acid-base treatment, coupling treatment, plasma treatment or oxidation/reduction treatment. These pigments can be used either singly or in combination of two or more.

It is normally preferred for these pigments (B) to have an average particle size within a range of 0.01-0.5 μm, in particular, 0.01-0.3 μm.

Pigment Formulations

A pigment formulation according to the present invention can be prepared, for example, by adding pigment (B) to a solution of resin (A) obtained by solution polymerization, mixing thoroughly, removing the solvent and pulverizing the remaining solid. Whereas, it is generally preferred to formulate it by mixing resin (A) powder with pigment (B) powder, melt-kneading the mixture and crushing or pulverizing the same. The blend ratio of resin (A) and pigment (B) in that occasion is suitably variable according to intended utility of resulting pigment formulation, while it is normally preferred to fall in within a range of 10/90-60/40, in particular, 20/80-50/50, inter alia, 25/75-35/65, in terms of mass ratio of pigment (B)/resin (A), in consideration of the resin adsorption onto pigment surface.

To the powdery mixture of resin (A) and pigment (B), plasticizing agent may be added where necessary, whereby making it possible to lower the treating temperature at the time of melt-kneading. As useful plasticizing agent, for example, phthalic acid ester, trimellitic acid ester, adipic acid ester, non-cyclic aliphatic dicarboxylic acid ester, phosphoric acid ester, fatty acid ester, hydroxycarboxylic acid ester and epoxide derivatives can be named. These can be used either singly or in combination of two or more.

Where a plasticizing agent is blended, its blend ratio can be within a range of normally 1-20 mass parts, preferably 1-10 mass parts, per 100 mass parts of resin (A) and pigment (B) as combined, in consideration of ease in melt-kneading.

To the powdery mixtures of resin (A) and pigment (B), synergist can be blended where necessary, with the view to impart to the pigment formulations dispersibility, fluidability and storage stability. Synergist signify pigments or skeletal structures analogous thereto into which basic groups or acidic groups are introduced. More specifically, for example, SOLSPERS 5000 (a phthalocyanine synergist, The Lubrizol Corp., tradename) can be named. Where such a synergist is blended, its blend ratio can be normally within a range of 1-30 mass parts, in particular, 5-15 mass parts, per 100 mass parts of resin (A) and pigment (B) as combined, in consideration of easy resin adsorption onto the pigment surface.

Furthermore, pigment dispersant, surfactant or the like can suitably be blended into the powdery mixture of resin (A) and pigment (B), where necessary.

Melt-kneading of resin (A) powder and pigment (B) powder can be conducted, for example, by feeding the powdery mixture into a kneading extruder at temperatures not higher than the glass transition temperature of the copolymer(s) constituting the resin (A), then raising the temperature to one not lower than the softening point of the resin (A), and kneading it in the kneading extruder with agitation power of at least 0.5 kW/hr. kg, in particular, at least 1-3 kW/hr. kg, whereby to provide a pigment formulation excelling in pigment dispersibility. As the kneading extruder, for example, single or twin screw extruder, single or twin screw kneader or the like can be used.

Powdery pigment formulations of the present invention can be obtained by cooling extrudate as obtained in the above where necessary, and crushing and/or pulverizing the same. The crushing and/or pulverization of the extrudate can be carried out with ordinary resin crusher, for example, ACM Pulverizer (Hosokawa Micron Co., tradename).

Thus obtained powdery pigment formulations preferably have an average particle size within a range of 10-300 μm, in particular, 30-100 μm.

Thus prepared powdery pigment formulations may also be used for coloring resin shaped articles, while they can be advantageously blended with, in particular, paint or ink. Paints with which the pigment formulations of the present invention can be blended are not subject to any particular limitation. That is, the pigment formulations of the invention are applicable to any types of paints generally used in the field of paint. More specifically, for example, liquid paint, in which a resin composition containing acrylic resin, polyester resin, silicon resin, fluorinated resin or alkyd resin as the main resin and melamine resin, (blocked)polyisocyanate compound, polyhydrazide compound, polyepoxide, polycarboxylic acid (or anhydride thereof) or hydroxyalkylamide compound, as the hardening agent, is used as the vehicle component which is dissolved or dispersed in water or organic solvent (organic solvent-based, water-based, water-dispersed, or non-aqueous dispersion type paints); and powder paint comprising powder of said resin composition can be named. These paints can further suitably contain, where necessary, paint additives such as hardening catalyst, UV absorber, surface treating agent, rheology-controlling agent, antioxidant, defoaming agent, anti-popping agent, wax and the like.

Blend ratio of a pigment formulation of the present invention with paint is subject to no particular limitation, and it is suitably variable according to intended paint color, for example, while normally it can be within a range of 1-100 mass parts, preferably 1-75 mass parts, inter alia, 1-50 mass parts, per 100 mass parts (solid component) of said resin composition.

### EXAMPLE

Hereinafter the present invention is explained more specifically, referring to working Examples, in which “part” and “%” are “mass part” and “mass %”, unless otherwise specified.

Preparation of Resin Powder

### Preparation Example 1

An ordinary acrylic resin reaction tank equipped with a stirrer, thermometer and reflux condenser tube was charged with 50 parts of toluene which was heated under stirring until its temperature reached 110° C. Then a monomeric mixture of the following composition was dropped thereinto consuming 3 hours:

| | | |
|---|---|---|
| methyl methacrylate | 38 | parts |
| styrene | 38 | parts |
| n-butyl acrylate | 17 | parts |
| 2-hydroxyethyl methacrylate | 5 | parts |
| methacrylic acid | 1 | part |
| N,N-dimethylaminoethyl methacrylate | 1 | part |
| 2,2′-azobisisobutyronitrile | 4 | parts |
| toluene | 2 | parts. |

After termination of the dropping, the system was maintained at 110° C. for further 30 minutes, and then into which an additional liquid catalyst mixture composed of 0.5 part of 2,2′-azobisisobutyronitrile and 10 parts of toluene was dropped, consuming an hour. The stirring was continued for another hour at 110° C., and then the reflux condenser tube was switched to a water lo separator and the most part of the toluene was distilled off while the temperature was raised to 160° C. Then the solvent was further removed under reduced pressure using vacuum pump, to provide a resin powder (A-1).

### Preparation Examples 2 -4 and Comparative Preparation Examples 1-3

Preparation Example 1 was repeated except that composition of the monomeric mixture was changed for each run as in the following Table 1, to provide resin powders (A-2) to (A-7). Weight-average molecular weights and glass transition temperatures of these resins are concurrently shown in the same Table 1, together with their softening points.

TABLE 1

| | | | | | | Comparative | | |
|---|---|---|---|---|---|---|---|---|
| | | Preparation Example | | | | Preparation Example | | |
| | | 1 | 2 | 3 | 4 | 1 | 2 | 3 |
| Resin Powder No. | | A-1 | A-2 | A-3 | A-4 | A-5 | A-6 | A-7 |
| Composition | methyl methacrylate | 38 | 38 | 36 | 37 | 39 | 33 | 33 |
| of | styrene | 38 | 38 | 36 | 37 | 38 | 30 | 30 |
| Monomeric | n-butyl acrylate | 17 | 15 | 17 | 17 | 17 | 30 | 30 |
| Mixture | 2-hydroxyethyl acrylate | | | | | | 5 | 5 |
| | 2-hydroxyethyl methacrylate | 5 | 5 | 5 | 5 | 5 | | |
| | acrylic acid | | | | | | 1 | 1 |
| | methacrylic acid | 1 | 1 | 1 | 1 | 1 | | |
| | N,N-dimethylaminoethyl methacrylate | 1 | 3 | | | | 1 | |
| | 2-(methacryloyloxy)ethyltrimethylammonium | | | 5 | | | | |
| | chloride | | | | | | | |
| | t-butylacrylamidosulfonic acid | | | | 3 | | | 1 |
| | 2,2′azobisisobutyronitrile | 4 | | 4 | 4 | 4 | 4 | 4 |
| | t-butylperoxy-2-ethyl hexanoate | | 4 | | | | | |
| | toluene | 2 | 2 | 2 | 2 | 2 | 2 | 2 |
| weight-average molecular weight | | 16000 | 18000 | 16000 | 16000 | 16000 | 16000 | 16000 |
| glass transition temperature (° C.) | | 60 | 60 | 56 | 58 | 60 | 26 | 26 |
| | softening point of resin powder (° C.) | 90 | 90 | 86 | 88 | 90 | 46 | 46 |

Preparation of Pigment Formulations

### Examples 1-3 and Comparative Examples 1-2

A pigment, resin powder, plasticizing agent and synergist were fed in a container rotatory mixer of 20 liters in capacity, and pre-mixed by stirring with a power of 3600 rpm×30 sec/kg. The resulting mixture was thrown into a kneading extruder and melt-kneaded under the conditions as given in Table 2. The extrudate was pulverized with a sample mill to provide a pigment formulation having average particle diameter of 100 μm. However, in case of Comparative Example 2, extensive blocking took place during the pre-mixing and the product's supply into the kneading extruder was difficult, resulting in failure to provide any pigment formulation.

Four (4) parts each of the formed pigment formulations was mixed with 7 parts of the resin powder (A-5) as obtained in Comparative Preparation Example 1 and 11 parts of toluene, and the resulting test solutions were each applied onto PET film to a coating film thickness of 75 μm with doctor blade and dried to provide test pieces. Jet black quality, gloss and degree of dispersion of each test piece were evaluated by the following methods. The results were as shown concurrently in Table 2. In the same table, (note 1)-(note 3) signify the following:
(note 1) carbon black pigment: “Raven 5000 Ultra III” Columbia Carbon Co., tradename
(note 2) plasticizer: butylbenzyl phthalate
(note 3) synergist: “SOLSPERS 5000”, The Lubrizol Corporation, tradename.
   Evaluation Methods

Jet black quality:

Jet black quality of the coating film on each test piece was evaluated in terms of L* which is a value index specified by JIS Z-8105. Lower numerical values of L* indicate more favorable jet black quality.

Gloss

Following JIS K-5600, 60° specular reflectivity of the coating film on each test piece was measured.

Degree of Dispersion:

This was measured following the degree of dispersion by JIS K-5600 fineness gauge method.

TABLE 2

| | | | | | Comparative | |
|---|---|---|---|---|---|---|
| | | Example | | | Example | |
| | | 1 | 2 | 3 | 1 | 2 |
| Blend | carbon black pigment | 25 | 25 | 25 | 25 | 25 |
| | (note1) | | | | | |
| | resin powder (A-1) | 75 | 70 | 70 | | |
| | resin powder (A-5) | | | | 75 | |
| | resin powder (A-6) | | | | | 75 |
| | plasticizing agent (note | | 5 | | | |
| | 2) | | | | | |
| | synergist | | | 5 | | |
| | (note 3) | | | | | |
| Kneading | feeding temperature | 27 | 27 | 27 | 27 | — |
| Condition | into kneading extruder | | | | | |
| | (° C.) | | | | | |
| | process rate (kg/hr) | 8 | 8 | 8 | 8 | — |
| | dispersing temp. (° C.) | 60-80 | 55-70 | 60-80 | 60-80 | — |
| | maximum shear rate | 210 | 210 | 210 | 210 | — |
| | (s⁻¹) | | | | | |
| | agitation power | 0.75 | 0.75 | 0.75 | 0.75 | — |
| | (kW/hr · kg) | | | | | |

| | | | | | |
|---|---|---|---|---|---|
| Jet black quality (L*) | 0.83 | 0.83 | 0.75 | 1.78 | — |
| gloss | 96.2 | 94.8 | 97.1 | 92.7 | — |
| degree of dispersion (μm) | 10> | 10> | 10> | 10> | — |

### Example 4 and Comparative Example 3

A pigment and resin powder were fed in a container rotatory mixer of 20 liters in capacity, and pre-mixed by stirring with a power of 3600 rpm×30 sec/kg. The resulting mixture was thrown into a kneading extruder and melt-kneaded under the conditions as given in Table 3. The extrudate was pulverized with a sample mill to provide pigment formulations having average particle diameter of 100 μm.

Ten (10) parts each of the pigment formulations was mixed with 30 parts of toluene, and the resulting test solutions were each applied onto PET film to a coating film thickness of 50 μm with doctor blade and dried to provide test pieces. Jet black quality, gloss and degree of dispersion of each test piece were evaluated by the ealier described methods. The results were as shown concurrently in Table 3. In the same table, (note 4) signifies the following:

(note 4) Quinacridone Magenta pigment: “MAGENTA RT355D”, Ciba Specialty Chemicals, an organic red pigment, tradename.

TABLE 3

| | | | Comparative |
|---|---|---|---|
| | | Example | Example |
| | | 4 | 3 |
| Blend | Quinacridone Magenta | 50 | 50 |
| | pigment (note 4) | | |
| | resin powder (A-3) | 50 | |
| | resin powder (A-5) | | 50 |
| Kneading | feeding temperature into | 27 | 27 |
| Condition | kneading extruder (° C.) | | |
| | process rate (kg/hr) | 10 | 10 |
| | dispersing temp. (° C.) | 60-80 | 60-80 |
| | maximum shear rate (s⁻¹) | 250 | 210 |
| | agitation power (kW/hr · kg) | 0.7 | 0.7 |

| | | |
|---|---|---|
| gloss | 78 | 65 |
| degree of dispersion (μm) | 10> | 10> |

### Example 5 and Comparative Examples 4-5

Pigment and resin powders were fed into a container rotatory mixer of 20 liters in capacity at blend ratios as shown in the following Table 4, and pre-mixed by stirring with the power of 3600 rpm×30 sec/kg. Resulting mixtures were thrown into kneading extruder and melt kneaded under the conditions indicated in Table 4. The extrudates were pulverized with sample mill to provide pigment formulations having average particle diameter of 100 μm. In case of Comparative Example 5, however, heavy blocking took place during the pre-mixing, which rendered the mixture's supply into the kneading extruder difficult and resulted in failure to provide a pigment formulation.

Three (3) parts each of the resulting pigment formulations were mixed with 7 parts of toluene, and the formed test solutions were applied onto PET film to a coating film thickness of 45 μm with doctor blade, followed by drying to provide test pieces. L*, a* and b* values of coating films on the test pieces were evaluated by the following methods, and gloss and degree of dispersion were evaluated by the earlier described methods. The results are shown concurrently in Table 4, in which (note 5) signifies the following:
(note 5) Copper Phthalocyanine Blue pigment: Toyo Inc Manufacturing Co., an organic blue pigment, tradename “700 Cyanine Blue.”
   Evaluation Methods

L*, a* and b* of coating film on each test piece were measured with “Color View Spectrophotometric Color Meter (BYK-Chemie).

TABLE 4

| | | | Comparative | |
|---|---|---|---|---|
| | | | Example | |
| | | Example 5 | 4 | 5 |
| Blend | Copper Phthalocyanine Blue | 40 | 25 | 25 |
| | pigment (note 5) | | | |
| | resin powder (A-4) | 60 | | |
| | resin powder (A-5) | | 75 | |
| | resin powder (A-7) | | | 75 |
| Kneading | supply temp. to kneading | 27 | 27 | — |
| Condition | extruder (° C.) | | | |
| | process rate (kg/hr) | 10 | 10 | — |
| | dispersing temp. (° C.) | 60-80 | 80-100 | — |
| | maximum shear rate (s⁻¹) | 250 | 250 | — |
| | stirring power (kW/hr · kg) | 0.7 | 0.7 | — |

| | | | |
|---|---|---|---|
| L* | 10.62 | 60-80 | — |
| a* | 10.26 | 210 | — |
| b* | −18.01 | −17.66 | — |
| gloss | 80.3 | 74.9 | — |
| degree of dispersion (μm) | 10> | 10> | — |

### Example 6 and Comparative Example 6

Pigment and resin powders were fed into a container rotatory mixer of 20 liters in capacity at blend ratios as shown in the following Table 5, and pre-mixed by stirring with the power of 3600 rpm×30 sec/kg. Resulting mixtures were thrown into kneading extruder and melt kneaded under the conditions indicated in Table 4. The extrudates were pulverized with sample mill to provide pigment formulations having average particle diameter of 100 μm.

Ten (10) parts each of the resulting pigment formulations were blended with 100 parts by weight of a glycidyl-containing acrylic resin (a resin obtained through polymerization of glycidyl methacrylate/styrene/methyl methacrylate/organic peroxide at copolymerization ratios of 43/10/47/10.5: weight-average molecular weight=5,000; softening point=80° C.), 46.8 wt parts of didodecanoic acid, 0.4 part of surface-treating agent and 1 part of anti-popping agent (benzoine), melt-kneaded, cooled, pulverized and filtered to provide powder paints having average particle diameter of about 40 μm.

Thus obtained powder paints were applied by means of electrostatic powder coating onto tin plate, to a dry coating film thickness of about 50 μm, and baked at 180° C. for 30 minutes. Jet black quality and gloss of resulting test plates were evaluated by the earlier described methods, with the results as concurrently shown in Table 5 in which (note 6) signifies the following:

(note 6) carbon black pigment: “CARBON MA-100B”, Mitsubishi Chemical Corporation, tradename.

TABLE 5

| | | | Comparative |
|---|---|---|---|
| | | Example | Example |
| | | 6 | 6 |
| Pigment | carbon black pigment (note 6) | 45 | 45 |
| formulation | resin powder (A-2) | 55 | |
| blend | resin powder (A-5) | | 55 |
| Kneading | supply temp. to kneading | 27 | 27 |
| Condition | extruder (° C.) | | |
| | process rate (kg/hr) | 4 | 4 |
| | dispersing temp. (° C.) | 60-80 | 60-80 |
| | maximum shear rate (s⁻¹) | 105 | 105 |
| | stirring power (kW/hr · kg) | 0.75 | 0.75 |

| | | |
|---|---|---|
| Jet black quality (L*) | 2.89 | 3.53 |
| gloss | 94.8 | 85.6 |

Claims:

1. A pigment formulation which is a powdery pigment formulation comprising resin (A) and pigment (B) as dispersed in the resin matrix, characterized in that the resin (A) is composed of a copolymer containing polymerizable unsaturated monomer (a) units having at least one kind of functional group selected from the group consisting of tertiary amino, quaternary ammonium salt and sulfo groups, and other ethylenically unsaturated monomer (b) units, and having glass transition temperature within a range of 40-150° C.

2. A pigment formulation according to claim 1, in which the monomer (a) is selected from N,N-dimethylaminoethyl(meth)acrylate, N,N-diethylaminoethyl(meth)acrylate, 2-(methacryloyloxy)-ethyltrimethylammonium chloride and 2-acrylamido-2-methylsulfonic acid.

3. A pigment formulation according to claim 1, in which at least a part of the other ethylenically unsaturated monomer (b) is hydroxyl-containing polymerizable unsaturated monomer.

4. A pigment formulation according to claim 1, in which at least a part of the other ethylenically unsaturated monomer (b) is carboxyl-containing polymerizable unsaturated monomer.

5. A pigment formulation according to claim 1, in which the copolymer is one obtained by copolymerization of 0.1-20 mass % of monomer (a) and 80-99.9 mass % of monomer (b), based on the combined amount of the monomer (a) and monomer (b).

6. A pigment formulation according to claim 1, in which the copolymer has a weight-average molecular weight within a range of 500-100,000.

7. A pigment formulation according to claim 1, in which the resin (A) has a softening point within a range of 40-200° C.

8. A pigment formulation according to claim 1, in which the copolymer has a glass transition temperature within a range of 50-120° C.

9. A pigment formulation according to claim 1, in which the mixing ratio of the resin (A) and pigment (B) is within a range of 10/90-60/40, in terms of the mass ratio of pigment(B)/resin (A).

10. A pigment formulation according to claim 1, which is obtained by melt-kneading resin (A) powder and pigment (B) powder, and thereafter crushing and/or pulverizing the melt-kneaded product.

11. A pigment formulation according to claim 10, which is obtained by supplying a powdery mixture of resin (A) and pigment (B) into a kneading extruder at a temperature not higher than the glass transition temperature of the copolymer of the resin (A), then raising the temperature to not lower than the softening point of the resin (A), and kneading the mixture in the kneading extruder with an agitation power of at least 0.5 kW/hr. kg.

12. A pigment formulation according to claim 11, in which the powdery mixture of resin (A) and pigment (B) further contains plasticizer.

13. A paint composition which comprises a pigment formulation as set forth in any one of claims 1-12.
